(19) United States
(12) Patent Application Publication
(10) Pub. No.: US 2006/0128546 A1
(43) Pub. Date: Jun. 15, 2006

(54) Glass-ceramic composite material, ceramic film layer composite or microhybird comprising said composite material and method for production thereof

(76) Inventors: Heike Schluckwerder, Stuttgart (DE); Ulrich Eisele, Stuttgart (DE)

Correspondence Address: KENYON & KENYON LLP, ONE BROADWAY, NEW YORK, NY, 10004, US

(21) Appl. No.: 10/523,251

(22) PCT Filed: Mar. 28, 2003
(86) PCT No.: PCT/DE03/01034

§ 371 Date: Aug. 30, 2005

(30) Foreign Application Priority Data
Jul. 27, 2002 (DE) 102 34 364.0

(51) Int. Cl. C03C 14/00; C03C 10/12

(52) U.S. Cl. 501/7; 501/32; 65/33.1; 264/646; 264/647

(57) ABSTRACT

A glass-ceramic composite material is described having a matrix that is at least from place to place of a glass type, and having a ceramic filler as well as a ceramic foil, a ceramic laminate or microhybrid using this composite material, the matrix containing lithium, silicon, aluminum and oxygen, and has at least from place to place a crystalline phase. In addition, a method is described for producing it, a glass having crystalline regions being melted from a starting mixture having 20 wt. % to 68 wt. % SiO₂, 10 wt. % to 25 wt. % Al₂O₃, 5 wt. % to 20 wt. % Li₂O, 0 wt. % to 35 wt. % B₂O₃, 0 wt. % to 10% P₂O₅, 0 wt. % to 10 wt. % Sb₂O₃ and 0 wt. % to 3 wt. % ZrO₂ and converted into a glass powder, a ceramic filler, particularly powdered aluminum nitride, being then mixed in with the glass powder, and this powder mixture is finally sintered, especially after the addition of further components.

### FIELD OF THE INVENTION

The present invention relates to a glass-ceramic composite material, a ceramic substrate, a ceramic laminate or a microhybrid having this ceramic composite material, as well as a method for producing the composite material or component parts having it.

### BACKGROUND INFORMATION

Substrate materials for LTCC applications (“low temperature co-fired ceramics”) have been developed in the past few years, above all with the aim of reducing the sintering temperature, in order to make possible co-firing, that is, sintering of the entire composite material in one step, with low-melting metals, such as silver. In this context, the compatibility with the metal should be ensured at the same time. It was also an aim to improve the dielectric properties of the LTCC substrate, especially for applications in the high frequency range, and to increase their heat conductivity with regard to heat dissipation from the LTCC substrates.

A glass-aluminum nitride composite material is described in European Patent No. EP 0 499 865 A1, which has a comparatively high heat conductivity at a low sintering temperature, and has good dielectric properties. This composite material starts from a glass powder having silicon dioxide, aluminum oxide, boron oxide and an alkaline earth metal oxide such as MgO, CaO or SrO, to which aluminum nitride is added as a ceramic powder component. Upon sintering the starting mixture to the composite material described in European Patent No. EP 0 499 865 A1, if MgO is used, cordierite is formed, and if CaO is used, anorthite is formed, while the glass matrix becomes impoverished in silicon, magnesium and aluminum.

### SUMMARY

An object of the present invention is to make available a glass-ceramic composite material, especially a substrate material for LTCC applications, which is able to be processed to a ceramic substrate and is able to be used in a ceramic laminate or in a microhybrid, and which has a high overall heat conductivity, if possible in the range of 8 W/mK to 12 W/mK.

The glass-ceramic composite material according to an example embodiment of the present invention may be very suitable as a substrate material for LTCC substrates and for the construction of microhybrids having such substrates, and may have a clearly increased heat conductivity, especially in the favorable range of 8 W/mK to 12 W/mK, compared to the usual LTCC substrate materials, whose heat conductivity usually lies between 2 W/mK to 3 W/mK. In this way, the number of required heat dissipations, which are designed in the case of microhybrids, as a rule, as thermal lead-throughs, or so-called “thermal vias”, i.e., channels filled with a metal that cross the substrate, may be reduced. Thereby comes about the possibility of clearly reducing the size of such microhybrids and of increasing the layout density.

A ceramic laminate produced using the glass-ceramic composite material according to the present invention, or a microhybrid based on an LTCC substrate having this glass-ceramic composite material, consequently offers the possibility of saving on thermal vias and of achieving a greater integration density. Finally, silver, that is usually used for filling the thermal vias, will also be saved in part by reducing their numbers.

It may be especially advantageous if the ceramic filler is aluminum nitride having an average powder particle size of 100 nm to 10 μm, especially from 1 μm to 10 μm. In this context, the filler may be uncoated aluminum nitride that has an average particle size such as 1 μm to 3 μm, preferably, coated aluminum nitride having an average particle size such as 6 μm to 7 μm, the coating being preferably a hydrophobic surface modification or an oxygen-containing surface coating. It may be particularly advantageous if the aluminum nitride powder used, especially because of the oxygen-containing surface coating, has an oxygen content of 0.5 wt. % to 2.0 wt. %, it being generally accepted that a lower oxygen content leads to an increased heat conductivity of the aluminum nitride-ceramic powder used.

In addition it may be advantageous if the matrix has as the crystalline phase a Li—Al—Si₂O₃ mixed crystal and/or an Li—Al—Si oxynitride and/or an Li—Al silicate and/or a lithium silicate as the crystalline phase as well as being further made up of a residual glass phase in which nitrogen is soluble at least in small proportions. It is of especial advantage if the matrix contains no lithium silicate, if possible, or as little of it as possible. Furthermore, it may be advantageous if B₂O₃ is also put into the starting mixture, so that, at least from place to place, an Li—B oxide may be created as crystalline phase in the matrix.

The proportion of the ceramic fillers in the composite material is preferably between 25 vol. % and 70 vol. %, especially 30 vol. % to 50 vol. %. It is particularly simple to set a heat conductivity in the range aimed for of 8 W/mK to 12 W/mK via the filler proportion.

### BRIEF DESCRIPTION OF THE DRAWINGS

The present invention will be explained in more detail with reference to the figure and in the description below.

FIG. 1 shows a top view of a microhybrid having an LTCC substrate as the ceramic substrate.

### DETAILED DESCRIPTION OF EXAMPLE EMBODIMENTS

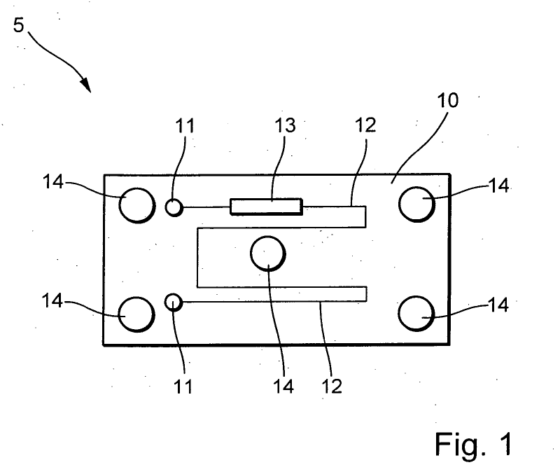

FIG. 1 shows a microhybrid 5, having a ceramic substrate 10 in the form of an LTCC foil or an LTCC laminate, substrate 10 having, from place to place, thermal lead-throughs 14, so-called “thermal vias”, which cross substrate 10 and which are filled with a metal, for example, silver. Furthermore, electrical lead-throughs 11, so-called “electrical vias”, that cross the substrate 10, are provided, whereby printed circuit traces running on the upper side of substrate 10 are able to be contacted from the lower side of substrate 10. Finally, on the upper side of substrate 10 there is shown, as an example, a printed-on resistor 13 that is also connected to the printed-on printed circuit traces 12.

The present invention relates to making available a glass-ceramic composite material for producing substrate 10 according to FIG. 1.

For this, one first melts a glass from a starting mixture having 20 wt. % to 68 wt. % SiO₂, 10 wt. % to 25 wt. % Al₂O₃, 5 wt. % to 25 wt. % Li₂O, 0 wt. % to 33 wt. % B₂O₃, 0 wt. % to 10% P₂O₅, 0 wt. % to 10 wt. % Sb₂O₃ and 0 wt. % to 3 wt. % ZrO₂.

Preferably, the starting mixture is made up of 48 wt. % to 66 wt. % SiO₂, 14 wt. % to 22 wt. % Al₂O₃, 4 wt. % to 20 wt. % Li₂O, 0 wt. % to 20 wt. % B₂O₃, 0 wt. % to 5 wt. % P₂O₅, 0 wt. % to 5 wt. % Sb₂O₃ and 0 wt. % to 2 wt. % ZrO₂.

In the case of the components B₂O₃, P₂O₅, Sb₂O₃ and ZrO₂, these are especially preferably added in a proportion of 3 wt. % to 20 wt. % B₂O₃ and/or 2 wt. % to 5 wt. % P₂O₅ and/or 1 wt. % to 5 wt. % Sb₂O₃ and/or 1 wt. % to 2 wt. % ZrO₂.

Within the scope of a first exemplary embodiment, the starting mixture is made up of 65 wt. % SiO₂, 15 wt. % Al₂O₃ and 20 wt. % Li₂O.

Within the scope of a second exemplary embodiment, the starting mixture is made up of 65 wt. % SiO₂, 15 wt. % Al₂O₃, 12 wt. % Li₂O and 8 wt. % B₂O₃.

In a third exemplary embodiment, the starting mixture is made up of 50 wt. % SiO₂, 16 wt. % Al₂O₃, 12 wt. % Li₂O and 20 wt. % B₂O₃.

In a fourth exemplary embodiment, the starting mixture is made up of 65 wt. % SiO₂, 21 wt. % Al₂O₃, 4 wt. % Li₂O, 4 wt. % B₂O₃, 4 wt. % P₂O₅ and 2 wt. % ZrO₂.

During the production of the glass from this starting mixture, a matrix is created that contains lithium, silicon, aluminum and oxygen, and which, from place to place, has at least one crystalline phase. This crystalline phase is, for instance, an Li—Al—Si₂O₃ mixed crystal, an Li—Al—Si oxynitride, a lithium silicate or a plurality of such crystalline phases. The non-crystalline regions of the matrix further form a residual glass phase in which, in a small proportion, nitrogen is soluble.

For the production of the above-named glasses, the powder components used in the starting mixture are homogenized and melted at temperatures between 1200° C. and 1600° C. After homogenization of the melt, this is then, for example, poured off into water, that is, it is shrended (crackled), and the glass thus obtained is milled down to an average grain size of 1 μm to 5 μm, for instance, 3 μm. After that, to this glass powder there is added, as ceramic filler, powdery aluminum nitride, having an average particle size of 100 nm to 10 μm, preferably 1 μm to 10 μm.

Within the scope of a first exemplary embodiment for producing the glass-ceramic composite material from the glass powder and the ceramic filler, one of the previously described glass powders and, as the ceramic filler, aluminum nitride powder, are homogenized in an organic solvent such as isopropanol, the powder mixture thus obtained is first dried, and is subsequently submitted to molding, such a uniaxial pressing.

After that, the pressed element obtained is sintered in air, nitrogen or a gas mixture containing oxygen and/or nitrogen at temperatures of at most 1050° C., so that one obtains thereafter a densely sintered glass-ceramic composite material in which, in a glass-type matrix, which from place to place has crystalline phases, the ceramic aluminum nitride particles are embedded.

On this glass-ceramic composite material, with the aid of the “hot disk method”, the heat conductivity was then determined. In this context, it was shown that the latter is a function of the proportion of the added ceramic filler.

Thus, in the case of a glass having 65 wt. % SiO₂, 15 wt. % Al₂O₃ and 20 wt. % Li₂O in the starting mixture for producing the glass and a proportion of 70 vol. % of this glass and 30 vol. % aluminum nitride particles in the glass-ceramic composite material, a heat conductivity of 9.1 W/mK was determined, and at a proportion of 65 vol. % of this glass and 35 vol. % of the aluminum nitride particles a heat conductivity of 8.9 W/mK was determined, and at 60 vol. % of this glass and 40% vol. % of the aluminum nitride particles a heat conductivity of 12.5 W/mK was determined.

It has generally been shown that the heat conductivity rises in the glass-ceramic composite material with increasing proportion of aluminum nitride.

The stagnant value of the heat conductivity at a composition of 65 vol. % glass and 35 vol. % aluminum nitride is attributed to the high proportion of crystalline lithium silicate formed. Therefore it is favorable if the glass-ceramic composite material contains as little as possible or no lithium silicate.

Testing for crystalline phases within the matrix of the glass-ceramic composite material and the verification of these phases, by the way, was done by X-ray diffractometry and scanning electron microscopy.

For the production of a ceramic foil, a ceramic laminate or a microhybrid 5 using substrate 10 made of the above-described glass-ceramic composite material, there is first produced one of the glasses described, it is ground down to the grain size described, and mixed with the described ceramic filler aluminum nitride. Thereafter, there is added to the powder mixture preferably additional, conventional components such as a solvent, an organic binding agent, as well as preferably also a dispersing agent, and then one carries out the forming of the mixture, especially to a foil, a layer or a laminate. After forming, first, preferably the binder is removed, and then the foil, layer or laminate is sintered at at most 1050° C. in air, nitrogen or a gas mixture containing oxygen and/or nitrogen. In this way, the added binder and the solvent as well as the dispersing agent are at least to a great extent removed again by pyrolysis, so as to create a glass-ceramic-composite material in the desired shape that is free from these temporary components. On the exemplary foil thus produced, which is used as substrate 10 for microhybrid 5, the latter is then constructed in the usual manner for this design layout technology.

1-14. (canceled)

15. A glass-ceramic composite material comprising at least from place to place a glass-type matrix and a ceramic filler, wherein the matrix contains lithium, silicon, aluminum and oxygen, and has at least from place to place at least one crystalline phase.

16. The glass-ceramic composite material as recited in claim 15, wherein the matrix contains 20 wt. % to 68 wt. % SiO₂, 10 wt. % to 25 wt. % Al₂O₃, 5 wt. % to 25 wt. % Li₂O, 0 wt. % to 35 wt. % B₂O₃, 0 wt. % to 10% P₂O₅, 0 wt. % to 10 wt. % Sb₂O₃ and 0 wt. % to 3 wt. % ZrO₂.

17. The glass-ceramic composite material as recited in claim 15, wherein the matrix is melted from a starting mixture that contains or is made of 20 wt. % to 68 wt. % SiO₂, 10 wt. % to 25 wt. % Al₂O₃, 5 wt. % to 25 wt. % Li₂O, 0 wt. % to 35 wt. % B₂O₃, 0 wt. % to 10% P₂O₅, 0 wt. % to 10 wt. % Sb₂O₃ and 0 wt. % to 3 wt. % ZrO₂.

18. The glass-ceramic composite material as recited in claim 16, wherein the matrix contains 48 wt. % to 66 at % SiO₂, 14 wt. % to 22 wt. % Al₂O₃, 4 wt. % to 20 wt. % Li₂O, 0 wt. % to 20 wt. % B₂O₃, 0 wt. % to 5% P₂O₅, 0 wt. % to 5 wt. % Sb₂O₃ and 0 wt. % to 2 wt. % ZrO₂.

19. the glass-ceramic composite material as recited in claim 17, wherein the starting mixture contains or is made of 48 wt. % to 66 at % SiO₂, 14 wt. % to 22 wt. % Al₂O₃, 4 wt. % to 20 wt. % Li₂O, 0 wt. % to 20 wt. % B₂O₃, 0 wt. % to 5% P₂O₅, 0 wt. % to 5 wt. % Sb₂O₃ and 0 wt. % to 2 wt. % ZrO₂.

20. The glass-ceramic composite material as recited in claim 16, wherein the matrix contains at least one of 3 wt. % to 33 wt. % B₂O₃, 2 wt. % to 5 wt. % P₂O₅, 1 wt. % to 5 wt. % Sb₂O₃, and 1 wt. % to 2 wt. % ZrO₂.

21. The glass-ceramic composite material as recited in claim 17, wherein the starting mixture contains at least one of 3 wt. % to 33 wt. % B₂O₃, 2 wt. % to 5 wt. % P₂O₅, 1 wt. % to 5 wt. % Sb₂O₃, and 1 wt. % to 2 wt. % ZrO₂.

22. The glass-ceramic composite material as recited in claim 15, wherein the ceramic filler is aluminum nitride having an average particle size of 100 nm to 10 μm.

23. The glass-ceramic composite material as recited in claim 22, wherein the ceramic filler has a coating.

24. The glass-ceramic composite material as recited in claim 15, wherein the matrix has, as a crystalline phase, at least one of an LiAlSi₂O₃ mixed crystal, an Li—Al—Si oxynitride, an Li—Al silicate, an Li silicate, and an Li—B oxide.

25. The glass-ceramic composite material as recited in claim 15, wherein the matrix has a residual glass phase in which nitrogen is soluble in a small proportion.

26. The glass-ceramic composite material as recited in claim 15, wherein a proportion of ceramic fillers in the composite material is between 25 vol. % and 60 vol. %.

27. The glass-ceramic composite material as recited in claim 26, wherein the proportion is between 30 vol. % and 50 vol. %.

28. The glass-ceramic composite material as recited in claim 15, wherein the composite material has a heat conductivity of 8 W/mK to 12 W/mK.

29. A ceramic foil, ceramic laminate or microhybrid, comprising:
a glass-ceramic composite material comprising at least from place to place a glass-type matrix and a ceramic filler, wherein the matrix contains lithium, silicon, aluminum and oxygen, and has at least from place to place at least one crystalline phase.

30. A method for producing a glass-ceramic composite material, a ceramic foil, a ceramic laminate or a microhybrid, comprising:
melting a glass having crystalline regions from a starting mixture having 20 wt. % to 68 wt. % SiO₂, 10 wt. % to 25 wt. % Al₂O₃, 5 wt. % to 20 wt. % Li₂O, 0 wt. % to 35 wt. % B₂O₃, 0 wt. % to 10% P₂O₅, 0 wt. % to 10 wt. % Sb₂O₃ and 0 wt. % to 3 wt. % ZrO₂;
converting the glass to a glass powder;
mixing a ceramic filler in with the glass powder; and
sintering the powder mixture.

31. The method as recited in claim 30, wherein the ceramic filler is powdered aluminum nitride.

32. The method as recited in claim 31, wherein the powder mixture is sintered after an addition of further compound.

33. The method as recited in claim 32, wherein the powder mixture is pressed before the sintering.

34. The method as recited in claim 32, wherein before the sintering, the powder mixture is formed to a foil, layer or laminate.

35. The method as recited in claim 30, wherein the sintering is performed at a temperature of at most 1050° C. in one of air, nitrogen, or a gas mixture containing at least one of oxygen and nitrogen.

36. The method as recited in claim 30, wherein the powder mixture is prepared before the sintering in a solvent while adding a dispersing agent, and an organic binder is added.
